(19) United States
(12) Patent Application Publication
(10) Pub. No.: US 2009/0169680 A1
(43) Pub. Date: Jul. 2, 2009

(54) PROCESS FOR THE MANUFACTURE OF A FROZEN DESSERT AND FROZEN DESSERT THUS OBTAINED

(75) Inventors: Jean-Luc Rabault, Ponthevrard (FR); Jean-Marc Philippe, Leuville Sur Orge (FR); Benedicte Flat, Palaiseau (FR)

Correspondence Address: YOUNG & THOMPSON, 209 Madison Street, Suite 500, ALEXANDRIA, VA, 22314, US

(73) Assignee: Compagnie Gervais Danone, Paris (FR)

(21) Appl. No.: 12/158,071

(22) PCT Filed: Dec. 20, 2006
(86) PCT No.: PCT/IB06/03711

§ 371 Date: Oct. 24, 2008

Related U.S. Application Data
(60) Provisional application No. 60/781,531, filed on Mar. 10, 2006.

(30) Foreign Application Priority Data
Dec. 21, 2005 (FR) 05 13082

(51) Int. Cl. A23G 9/46; A23G 9/20; A23G 9/36; A23G 9/04; A23G 9/34

(52) U.S. Cl. 426/61; 426/565; 426/566

(57) ABSTRACT

A process for the manufacture of a frozen dessert, includes the successive steps of: (a) freezing a mixture containing a fruit puree and/or juice, yoghurt and optionally added sugars and/or other ingredients, in order to obtain a frozen composition, (b) optionally bringing the frozen composition to a core temperature ranging from −15 to −25° C. or from −15 to −300° C., (c) placing the frozen composition in a device equipped with grinding elements and optionally with aerating elements, which device does not include extrusion members, and (d) texturing the frozen composition with the aid of the grinding and optionally aerating elements. It also relates to the frozen dessert thus obtained.

The present invention relates to a process for the manufacture of a frozen dessert based on yoghurt and fruit, and the frozen dessert thus obtained.

Tub or stick ice creams are very well liked by consumers, but generally have the disadvantage of being rich in sugars and fatty substances. Their calorie load is therefore very high.

In addition, their texture straight from the freezer is too hard, such that it is necessary to leave them to warm up for a while at room temperature before being able to taste them, with the risk that the bottom of the tub melts and impairs the texture of the ice cream at the next use, after it has been frozen again. To overcome this disadvantage, it is possible to increase the quantity of fat (in order to limit the propagation of ice crystals) and/or of sugars (in order to reduce the freezing point). These solutions are however not satisfactory from the nutritional point of view and can adversely affect the intensity and the natural character of the taste of the ice cream obtained.

A particular type of ice creams consists of yoghurt ice creams. They are in general less fatty than ice creams but even harder and less melting, with a sour and watery taste. In addition, they frequently contain more than about ten ingredients, which can pose allergy problems. The psychological perception of the product is additionally adversely affected since consumers increasingly tend to seek natural products containing as few additives and ingredients as possible.

Another type of ice cream also consists of so-called “Italian” type ice creams which are served extruded in a cone or a cup. These so-called Italian-type ice creams may contain yoghurt. They have a creamy texture resulting from their reduced serving temperature (−7 to −10° C.) and the high degree of overrun which is conferred on them. However, the machines producing these ice creams are designed for companies with a high sales volume, because of their cost and the need to have as many machines as flavors. They moreover cause significant losses since the mixture to be extruded must be discarded at most after three days. More recent machines are equipped with an automatic pasteurisation every night, which limits losses, because in this case the machine must be totally emptied every 15 days only. But obviously this system kills the living ferments of yoghurt.

A variant of these machines is manufactured by the company RESFAB (Canada) and is marketed by the company BIO-GOURT International Inc. (Vanier, Quebec-Canada). This apparatus is described in particular in U.S. Pat. No. 2,626,132 and U.S. Pat. No. 5,626,133. It makes it possible to prepare yoghurt and fruit ice creams from a yoghurt ice cream in the semisolid state and from frozen fruit pieces. The quantity of yoghurt in the finished product however does not exceed 14% by weight. Moreover, the ice cream obtained cannot be suitably stored without losing its texture, and cannot be molded into balls. It is not possible to prepare more than one portion at a time either. This solution is therefore not suitable for the manufacture of frozen desserts having good nutritional qualities, which can be offered in a restaurant or a canteen, for example, since it is impossible to simultaneously serve a large number of people. The machines described in U.S. Pat. No. 4,668,561 and U.S. Pat. No. 5,208,050 have the same disadvantages.

Sherbets are of course less fatty than ice creams, but contain more sugars and can have some blandness which results in a “watery” taste. They are even harder than ice creams straight from the freezer, because of the large ice crystals which they contain. These large crystals are also rough in the mouth, which is very unpleasant.

Sherbets and ice creams can be prepared using ice cream makers which make it possible to mix and freeze a mixture of water, sugar and fruits washed beforehand, peeled and reduced to a puree. Some ice cream makers (in particular PHILIPS HR2305) are provided with a recipe manual describing in particular the manufacture of yoghurt ice creams. Other yoghurt ice cream recipes are available on the Internet. While the nutritional benefits of these yoghurt ice creams are satisfactory overall, it is not conceivable to offer them on the scale of a restaurant, the hourly rate of production by these machines being insufficient.

Indeed, yoghurt ice creams require a fairly long time for preparing the fruit mixture, and then for freezing. In the case of ice cream makers with accumulators, the freezing is all the more problematic since it is necessary to have as many accumulators as ice cream batches which it is desired to prepare. In addition, these ice creams are difficult to preserve since they need to be consumed within ten minutes of their preparation or returned to the freezer for a period not exceeding one hour if they are not to become too hard. After freezing for one hour, it is theoretically possible to bring these ice creams back to a higher temperature, but this reheating gives them an inhomogeneous texture and does not remove all the crystals perceptible under the tongue. Finally, the ice creams thus prepared are not very reproducible in terms of texture. It will therefore be appreciated that ice cream or sherbets prepared following the recipes provided with ice cream makers do not have a sufficiently creamy and durable texture and that they are not suitable for other than domestic use.

A solution currently offered to restaurant owners for manufacturing creamy ice creams optionally containing yoghurt consists in using an apparatus manufactured by the company PACOJET AG (Zug, Switzerland) and marketed under the trade name Pacojet by the company PACOCLEAN (Romagnieu—FRANCE).

This apparatus, which is described in patent application CA-2,250,542, is a multifunctional food processor which makes it possible, in particular, to manufacture frozen desserts based on fruit and yoghurt. The manufacturer recommends in this case to prepare a mixture of fruit pieces (cooked or uncooked), sugar and cream, optionally supplemented with yoghurt and generally with water. This mixture is then frozen in special pots and then worked in the machine which grinds and possibly aerates (or “pacotizes”) the frozen mixture, or only part of it, until the creamy consistency of an Italian-type ice cream is obtained within a few minutes.

The supplier of Pacojet suggests in particular to “pacotize” a mixture containing: 30% of bananas (fruit), 48% of plain yoghurt, 12% of crème fraîche optionally replaced with low-fat yoghurt, and 10% of sugar.

While the use of an apparatus of the type described above effectively makes it possible to easily prepare, on the scale of a restaurant, frozen desserts having a suitable texture and relatively acceptable nutritional properties, it is still the case that the use of fresh fruit solely in the form of pieces poses several problems. In particular, for good operation of the apparatus and in order to obtain an ice cream with no crystals, it is necessary to completely fill the pot containing the mixture to be worked, and therefore to fill the empty spaces created by the fruit pieces with the aid of liquid cream or water whose role is also to dissolve the added sugar. Now, water leads to the formation of crystals which are damaging to the structure and the taste of the product, and the presence of cream is not always desirable given its calorific value. If the cream is not fermented, it also provides lactose which is not well digested by a significant part of the population. Moreover, fresh fruits are not available throughout the year and their perishable nature is a source of wastage. Finally, the use of fruit pieces does not make it possible to sufficiently grind the akenes of red fruit such as strawberry, mulberry or raspberry, and the seeds of fruits such as orange and grape.

In addition, the supplier of Pacojet recommends two runs of the mixture in the apparatus in order to obtain the desired homogeneity and a more creamy texture, which is not desirable either from an economic point of view, given the time required for the operation, or from the point of view of the texture obtained, which is then often too soft to allow the formation of nice ice cream balls.

Moreover, it is not evident that the recipe described above, which uses a large quantity of yoghurt, close to 50% by weight, can be used for fruits other than banana, which have a lower starch content and therefore texturing properties which are not as good as banana. It is indeed known that banana is a conventional texturant for milk shakes and smoothies.

It would therefore be desirable to have available a frozen dessert based on yoghurt and fruits, which can be served on the scale of a restaurant without causing losses which are too great and economically damaging, and which has a balanced nutritional profile, a low calorific value, an intense fruity taste and color and a creamy, stable and perfectly reproducible texture regardless of the fruit used, while being sufficiently firm for the dessert to be molded into balls.

The applicant company has had the merit of producing and developing such a frozen dessert which makes it possible to satisfy the need by meeting all the technical, nutritional and organoleptic requirements set out above, the said frozen dessert being prepared by texturing, in a suitable apparatus, a frozen composition comprising fruits in the form of a puree and/or juice, and yoghurt.

The subject of the present invention is therefore a process for the manufacture of a frozen dessert, comprising the successive steps consisting in:
(a) freezing a mixture containing a fruit puree and/or juice, yoghurt and optionally added sugars and/or other ingredients, in order to obtain a frozen composition,
(b) optionally bringing the said frozen composition to a core temperature ranging from −15 to −25° C. or from −15 to −30° C.,
(c) placing the said frozen composition in a device equipped with grinding means and optionally with aerating means, which device does not comprise any extrusion means, and
(d) texturing the said frozen composition with the aid of the said grinding and optionally aerating means.

The subject of the present invention is also a frozen dessert which can be obtained according to the process described above.

The first step of the process according to the invention uses a mixture containing a fruit puree and/or juice, yoghurt and optionally added sugars and/or other ingredients.

The first ingredient of the composition used in the invention is a fruit puree and/or juice.

The expression “fruit puree and/or juice” is understood to mean a preparation which is more or less liquid, particularly according to the nature of the fruit and/or the fineness of the grinding, prepared by grinding, pressing or otherwise extracting one or more fruits and optionally concentrating the ground product obtained and/or separating (such as filtering) the pips, akenes and/or all or some of the pulp, and/or flash pasteurization, the preparation containing no added sugar. As some commercial fruit purees contain added sugars, for example conventionally 10% sucrose, the added sugars will be counted as sugars and subtracted from the weight of the fruit puree, according to the invention.

For the purposes of the present invention, the above preparation (fruit puree and/or juice) consists of fruit having a small enough size to be able to pass through a sieve having a square mesh 3 mm along the side, the said sieve being optionally rinsed with water during the sieving in the case where the preparation is very viscous.

In the remainder of this description, the quantity of fruit puree and/or juice used according to the invention is expressed as fruit equivalent. The expression “fruit equivalent” is understood to mean the percentage of fruit puree and/or juice (as defined above) used, multiplied by the percentage of dry matter content of the fruit puree and/or juice used, divided by the percentage of mean dry matter content of a nonconcentrated puree of the edible part of these same fresh fruits. For example, in the case where the composition according to the invention contains 20% of a fruit puree concentrated two-fold (from which half of the water has been evaporated) and then sweetened at 10%, the fruit equivalent will be: 20×0.9×2/1=36%.

It is thus possible to use the standard fruit purees marketed by the company BOIRON FRERES SA (Rungis—FRANCE).

The frozen composition according to the invention preferably contains from 30 to 49% by weight, more preferably from 31 to 40% by weight and better still from 31 to 35% by weight of fruit puree and/or juice, as fruit equivalent, relative to the total weight of the composition. As a variant, however, the frozen composition may contain less than 30% by weight of fruit. According to an alternative of the invention, the frozen composition may contain from 49.1 to 220%, preferably from 50 to 150% and more preferably from 50 to 90% by weight of fruit puree and/or juice, as fruit equivalent, relative to the total weight of the composition.

The fruits may be chosen from: apple, banana, strawberry, peach, raspberry, mulberry, mango, kiwi, blueberry, blackcurrant, redcurrant, orange, cherry, fig, pear, apricot, coconut, passion fruit, guava, pawpaw, melon, litchi, pineapple, lemon, mandarin, cherry plum, grapefruit, grape, rhubarb and mixtures thereof, this list not being exhaustive.

It is preferable however that the composition is free of fruit containing in the fresh state more than 1.5% by weight of native starch, such as banana or chestnut.

In addition, it is preferable that the frozen composition does not contain more than 50% by weight, better still not more than 30% by weight of fruit pieces, relative to the total weight of the pureed fruits, fruit juice and fruit pieces, or even no fruit pieces, that is to say fruits capable of being retained on a sieve with a square mesh 3 mm along the side even after washing the sieve with water.

The second ingredient of the composition used according to the invention is yoghurt. The frozen composition preferably contains from 51 to 70% by weight, more preferably from 55 to 70% by weight and better still from 55 to 60% by weight of yoghurt, relative to the total weight of the composition.

For the purposes of the present invention, yoghurt is understood to mean a coagulated dairy product obtained by lactic acid fermentation by virtue of the action of thermophilic microorganisms obtained from cultures of Streptococcus thermophilus and Lactobacillus delbruekii bulgaricus, from milk and dairy products. It is the presence of these two bacterial strains which characterizes the name yoghurt, in accordance with the definition of the Codex alimentarius. These specific microorganisms are preferably viable, in an overall quantity of at least 10⁷ CFU/g at the best-before date, the abbreviations C.F.U meaning Colony Forming Unit. The lactic acid fermentation causes a reduction in the pH and coagulation.

Dairy products are in particular chosen from the group consisting of pasteurized milk, concentrated milk, pasteurized semiskimmed milk, concentrated semiskimmed milk, pasteurized skimmed milk, concentrated skimmed milk, pasteurized cream, pasteurized light cream and mixtures thereof.

The milk used for the manufacture of yoghurt may be cow's, goat's, buffalo's, soy or oat milk, or mixtures thereof, in particular. Cow's milk is preferred for use in the present invention.

In a wider sense, it is also possible to call yoghurt, for the purposes of the present invention, products comprising lactic acid bacteria, other than the microorganisms Streptococcus thermophilus and Lactobacillus delbruekii bulgaricus, and in particular microorganisms obtained from strains of Bifidobacterium animalis animalis and/or Lactobacillus casei and/or Lactobacillus plantarum and/or Lactobacillus acidophilus. These lactic acid strains are intended to confer various properties on the finished product, such as good balance of the flora. In the finished product, the microorganisms are preferably in the viable state. They thus improve the digestibility of the dessert manufactured from the composition according to the invention and confer probiotic properties on it.

Such a yoghurt thus advantageously meets the specifications for fermented milks and yoghurts of the AFNOR NF 04-600 standard and the codex StanA-11a-1975 standard. The AFNOR NF 04-600 standard specifies, inter alia, that the product must not have been heated after fermentation. Furthermore, in a yoghurt, the dairy products and the dairy raw materials must represent a minimum of 70% (m/m) of the finished product.

It is preferred that, in the present invention, a large quantity of live lactic ferments remain after freezing. Thus, the composition used according to the invention preferably contains at least 10⁵, preferably at least 10⁶, or even at least 10⁷ bacteria per gram. These bacteria advantageously contain at least one bacterium chosen from: (a) Streptococcus thermophilus, (b) Lactobacillus delbruekii bulgaricus, (c) Bifidobacterium animalis animalis, (d) Lactobacillus casei (e) Lactobacillus plantarum, (f) Lactobacillus acidophilus or mixtures thereof. Preferably, the bacteria contain a mixture of (a) Streptococcus thermophilus, (b) Lactobacillus delbruekii bulgaricus, and optionally also (c) Bifidobacterium animalis animalis and/or (d) Lactobacillus casei and/or (e) Lactobacillus plantarum and/or (f) Lactobacillus acidophilus.

Such a yoghurt is marketed in particular by the company DANONE under the trade name Activia (Streptococcus thermophilus, Lactobacillus delbruekii bulgaricus, Bifidobacterium animalis animalis).

According to a preferred variant of the invention, the frozen composition is free of unfermented cream. More preferably still, the yoghurt is the only dairy ingredient of the composition.

The expression “unfermented cream” is understood to mean a milk enriched with fatty substances, containing at least 30% by weight of fatty substances, in general 35% and even up to 40% by weight of fatty substances, which is in general liquid, at a pH close to 6.4 and is not acidified by lactic ferments.

The absence of cream makes it possible to reduce the number of ingredients of the composition and also to ensure better digestibility of lactose (recognized for yoghurt) and a higher concentration of bacteria in the finished product (higher proportion of yoghurt).

Likewise, the composition used according to the invention may be free of various food additives, as defined in the Codex alimentarius, whose presence is not necessary for obtaining the texture and/or taste desired for the frozen dessert according to the invention. The composition may also be free of lemon juice.

As a variant or in addition, it may be free of at least one of the following constituents: additives (within the meaning of Codex alimentarius), in particular texturants, emulsifiers, colorings, preservatives; starch; gelatin; flavors; egg yolk; and mixtures thereof. Preferably, the composition is free of all of these constituents.

The expression “texturants” is understood to mean compounds which modify the texture of the products into which they are incorporated. Examples of texturants are: guar and carob flours; gum arabic, xanthan gum, gellan gum; carrageenans; starches (native or modified); microcrystalline cellulose; gelatin; pectin; alginates (E400 to E405); agar; and mixtures thereof. The expression “emulsifiers” is understood to mean amphiphilic compounds characterized by their HLB (Hydrophilic Lipophilic Balance) value, in particular which are capable of stabilizing oil-in-water emulsions. Examples of food emulsifiers are lecithin and its derivatives present in particular in egg yolk; fatty acid mono- and diglycerides; polysorbate 80. The expression “colorings” is understood to mean compounds of natural or synthetic origin which are capable of conferring, on their own, a color on the composition. Examples of food colorings are known in Europe under the codes E100 to E180. The expression “preservatives” is understood to mean compounds which inhibit the proliferation of microorganisms, in particular yeasts and/or molds and/or bacteria, in particular Staphylococcus aureus, in the composition. Examples of food preservatives are sorbic acid and its salts (E200 to E203); benzoic acid and its salts (E210 to E219); sulfites and derivatives (E220 to E228); natamycin; nisin; and mixtures thereof. The expression “flavors” is understood to mean compounds of natural or synthetic origin which are capable, on their own, of modifying the taste of the composition. Examples of flavors are vanillin; natural vanilla extract; essential oils of added citrus fruit; and mixtures thereof.

On the other hand, the composition according to the invention may advantageously contain one or more nonhydrogenated vegetable oils containing unsaturated fatty acids, such as soybean, sunflower, oleic rapeseed, oleic sunflower, safflower, evening primrose or borage oils. More preferably, it will be possible to use one or more oils rich in fatty acids of the omega-3 type and optionally of the omega-6 type, preferably having a ratio of fatty acids of the omega-6 type to fatty acids of the omega-3 type of less than 5, such as nut, lupine, camelina, linseed, hemp, cranberry, Inca inchi, kiwi seed or rapeseed oil, preferably rapeseed oil because of its very neutral taste and its lower price.

In the case where nutritive oils are used as a partial or complete substitute for milk fat, the yoghurt and fruit dessert according to the invention, and therefore the frozen composition according to the invention, preferably have a content of fatty acids of the omega-3 type (as linolenic acid equivalent) greater than 0.3 g per 100 g of frozen dessert (for example provided by 3.3% of rapeseed oil). Preferably, the ratio of fatty acids of the omega-6 type to fatty acids of the omega-3 type is furthermore less than 5 and preferably less than 33% of the calories provided by the dessert (respectively the frozen composition) are of lipid origin.

In addition, when they are present in an amount of 5% by weight of the composition approximately, the fatty substances present in the yoghurt and/or added by the above oils confer on the frozen dessert prepared from the composition according to the invention a smooth appearance similar to that of butter, a melt-in-the-mouth texture and a hint of milky and possibly creamy notes. These product qualities, although less marked, are already perceptible at a fat content of 0.6%.

The applicant has additionally observed that the fruity taste is more intense in the case where the overall level of fatty substances is lower or when the fatty substances are provided by vegetable oils. In the latter case, the fruity color is additionally brighter.

The composition according to the invention contains, as a third constituent (optional), one or more added sugars (other than those naturally present in the fruits) in a quantity such that the composition contains less than 25% by weight, preferably less than 23% by weight and better still less than 21% by weight of carbohydrates, relative to the total weight of the composition. It additionally preferably contains more than 14% by weight of carbohydrates, relative to the total weight of the composition.

The expression sugar is understood to mean, for the purposes of the present invention, any sweetening carbohydrate, preferably sucrose, glucose, fructose, invert sugar, honey, maltose, or mixtures thereof, in particular in a 50:50 ratio. The sugar is preferably added in the form of a fine powder such as confectioner's sugar.

The frozen composition obtained by mixing the aforementioned ingredients advantageously has an energy value of less than or equal to 155 KCal/100 g, preferably of less than 140 KCal/100 g, more preferably of less than 120 KCal/100 g, or even less than 100 KCal/100 g. In addition, it preferably contains from 0 to 6%, or even from 0 to 5% and preferably from 0 to 1% by weight of fatty substances and/or from 1.5 to 3%, or even from 2 to 2.5% by weight of proteins and/or less than 25% by weight, preferably less than 23% by weight, better still less than 21% by weight of carbohydrates, relative to the total weight of the composition. The frozen dessert obtained from this composition therefore advantageously has the same calorific and nutritional values.

It is generally preferred that the frozen composition according to the invention contains a maximum of six ingredients, and better still only three, it being understood that all the fruits and flavors each count respectively as one ingredient.

To carry out the first step of the process according to the invention, use may be made of freezing either in a four-star freezer for a period of at least 12 hours, and preferably of at least 24 hours, or in a cell blowing a gas at −40° C. or less (conventional cold or cryogenic tunnel), for a more rapid deep-freezing, the latter alternative allowing better survival of the ferments and a smaller growth of the ice crystals, which will then be easier to grind. Obviously, it is also possible to freeze the mixture in step (a) at intermediate temperatures.

This freezing step is preferably performed so as to obtain a frozen composition having a core temperature of less than or equal to −15° C., preferably less than or equal to −18° C. and generally greater than or equal to −40° C.

The frozen composition thus obtained is generally very hard and cannot be sampled as it is but will be used to manufacture a frozen dessert.

It may have been frozen at a temperature of about −18° C., in which case it will be used as it is. In a preferred alternative, and as indicated above, the frozen composition may have been obtained or even stored at a lower temperature of up to −40° C. or even −80° C. The process may then comprise a second step consisting in bringing the temperature of the frozen composition to a core temperature ranging from −15 to −25° C., preferably from −17 to −21° C. It is however preferred to bring the temperature to a core temperature in the range of from −15 to −30° C., preferably from −20 to −30° C. and more preferably from −24 to −30° C. These conditions allow to obtain, whatever the way the composition has been prepared and frozen, very small crystals which are almost imperceptible to the consumer.

The third step of the process according to the invention consists in placing the frozen composition described above in a device intended to texture it.

At this stage, the composition may find itself packaged in a container specially adapted to the texturing device into which it has been poured before freezing. As a variant, however, the composition may find itself packaged in the container in which it was marketed before freezing, the latter being designed either to be placed directly in the texturing device, or to allow easy unmolding of the frozen composition which is then placed in a container specially adapted to the device.

In the latter subvariant, it will be advantageous to provide, in the process according to the invention, between steps (c) and (d), a step for causing the said frozen composition to cling in the container by one of the following two methods:
by impregnating a frozen composition with the aid of an aqueous liquid such as water. The impregnation may be performed either by dipping the frozen composition in water or another liquid, or by passing it under water, or by pouring a liquid into the empty space surrounding the block of frozen composition inside the container;
by heating, which allows superficial melting of the block of frozen composition,
   the nonfrozen part then being refrozen either by simple contact with the frozen pot, or by returning to the freezer.

This additional step avoids the rotation of the composition in the container, which is damaging to the good course of the subsequent texturing, and which could then adversely affect the homogeneity of the textured mixture.

In the fourth step of the process according to the invention, the frozen composition, optionally supplemented with water or another liquid such as milk, is then textured in the abovementioned texturing device which is provided with grinding means and optionally with aerating means.

Preferably, the grinding means comprise a grinding component provided with rotating blades, mounted at the end of an axle which is suitable for moving longitudinally, perpendicularly to the plane of the blades. In another embodiment, the grinding means provided with rotating blades, which is mounted at the end of an axle, is fixed and it is the pot which moves longitudinally, perpendicularly to the plane of the blades. For their part, the aerating means may consist of any means which makes it possible to supply air to the composition, generally under pressure. The grinding may also be performed at atmospheric pressure, in particular for fruits of light color and/or of milder taste, such as peach.

Advantageously, the device additionally comprises means for varying the ratio of the speed of rotation of the blades to the speed of longitudinal movement.

A device of this type has been described in particular in patent CA-2 250 542 and is for example marketed by the company PACOCLEAN under the trade name “Pacojet”.

This device makes it possible to grind the hard ice crystals and possibly to aerate them in order to obtain a frozen dessert having a smooth and melting texture and a temperature of −4 to −8° C., suitable for immediate sampling, in general within ten minutes, for example, in the form of balls or quenelles.

For organizational reasons, it may however be useful to store the dessert for longer before sampling. The process according to the invention may therefore comprise an additional step of storing the textured composition at a temperature of −18° C. for at most two hours, preferably at most one hour. This time period may be extended by thermally insulating the pot containing the dessert, so as to slow down its cooling and thus the recrystallization of the frozen dessert.

According to a preferred variant, the process described above rather comprises the additional step of storing the textured composition at a temperature ranging from −6 to −12° C., preferably at a temperature in the region of −10° C. The highest temperatures of this range are rather suitable for ventilated cold freezers and the lowest temperatures for static cold freezers. An example of apparatus which can be used to store the textured composition in the abovementioned temperature range is available from the company FRAMEC (Reventin-Vaugris, France).

This variant makes it possible to preserve the frozen dessert's sensory properties for several hours—up to about four hours—after manufacture. Moreover, for a storage between −6 and −10° C., the texture remains almost unchanged up to 7 hours after texturation, and the texture still remains acceptable (although a bit harder and granular, colder and a bit less fondant) up to 3 days of storage at this same temperature. Again, it is possible to thermally insulate the pot containing the dessert so as to slow down its cooling and thus extend the above time period. After several hours, if the texture of the dessert is considered too hard or “sandy” because of ice crystals which have become too large, it is preferable to refreeze it for at least about 10 hours at a temperature of less than or equal to −18° C., preferably from −24 to −30° C., before retexturing it.

The use of the composition and of the texturing process according to the invention has numerous advantages compared with other prior art compositions and processes.

In particular:
from the economic point of view, it is possible to manufacture fruit-based frozen desserts with no constraint for managing a stock of fresh fruits or for preparing (washing, peeling, stoning, pasteurizing, blanching) the fruits and to obtain frozen desserts with no additive or flavor, containing a small number of simple constituents, which may be reproduced in a perfectly reproducible manner with a wide variety of fruits available throughout the year, with no losses,
from the taste and nutritional point of view, the pureed fruits and/or fruit juice may have been subjected, before being introduced into the composition, to flash pasteurization which impairs the taste and the properties of the fruit less than pasteurization in a saucepan or in a batch tank, such that the frozen desserts thus obtained will have an intense and nonwatery fruity taste although preferably containing less than 50% by weight of fruit and will additionally offer the nutritional benefits of the fruits (vitamins, minerals, fiber, antioxidants and the like).

The invention will now be illustrated by the following nonlimiting examples.

### EXAMPLES

### Example 1

### Preparation of Frozen Desserts According to the Invention

Six desserts are prepared from the compositions indicated in table 1, according to the process described below.

TABLE 1
Examples of compositions

| | | Composition | Composition | Composition | Composition | Composition | Composition |
|---|---|---|---|---|---|---|---|
| | | 1 | 2 | 3 | 4 | 5 | 6 |
| Fruit(s) | Type | Raspberry | Raspberry | Mango | Blueberry | Raspberry | Raspberry |
| | | puree ⁽¹⁾ | puree ⁽¹⁾ | puree ⁽¹⁾ | puree ⁽¹⁾ | puree ⁽¹⁾ | puree ⁽¹⁾ |
| | Quantity | 31% | 31% | 31.6% | 31% | 44.1% | 30.6% |
| Yoghurt | Type | Danone plain | Danone plain | Danone plain | Danone plain | Danone plain | Danone plain |
| | | yoghurt cream | set Bio | set yoghurt | set yoghurt | yoghurt cream | yoghurt cream |
| | | (9% fat) ⁽²⁾ | yoghurt (3.4% | (1% fat) ⁽⁴⁾ | (1% fat) ⁽⁴⁾ | (9% fat) ⁽²⁾ | (9% fat) ⁽²⁾ |
| | | | fat) ⁽³⁾ | | | | |
| | Quantity | 54.1% | 54.1% | 54.1% | 51% | 51% | 66% |
| Added | Quantity | 14.9% | 14.9% | 14.3% | 13.8% | 4.9% | 3.4% |
| sugars ⁽⁵⁾ | | | | | | | |
| Other(s) | Type | — | — | — | Rapeseed oil | — | — |
| | Quantity | — | — | — | 4.2% | — | — |

⁽¹⁾ provided by BOIRON (flash pasteurized before deep-freezing).
⁽²⁾ consisting of a mixture of whole milk, cream, concentrated or powdered skimmed milk and yoghurt lactic ferments; containing 9% of fatty substances, 4.3% of carbohydrates, 3.2% of proteins and 83.5% of water and minerals.
⁽³⁾ consisting of milk containing 3.5% of fatty substances, powdered skimmed milk, lactic ferments including Bifidobacterium; containing 3.4% of fatty substances, 5% of carbohydrates, 3.7% of proteins and 87.9% of water and minerals.
⁽⁴⁾ consisting of milk containing 1.05% of fatty substances, concentrated or powdered skimmed milk, lactose, milk proteins, yoghurt lactic ferments; containing 1% of fatty substances, 6.8% of carbohydrates, 3.8% of proteins and 88.4% of water and minerals.
⁽⁵⁾ including that provided by the purees ⁽¹⁾ (sweetened to 10%)

### Process of Preparation:

### A. Production of Ready-to-Texture Frozen Compositions

Compositions 1 to 6 above may be commercially available in the form of ready-to-freeze mixtures, having a best-before date of 30 days at a temperature of less than 6° C. As a variant, they may be prepared by mixing, using a beater, the yoghurt with the fruit puree and/or juice and the added sugar, and optionally with rapeseed oil, the fruit puree being optionally thawed for 24 hours at 4° C. in the event that it is in deep-frozen form.

These compositions are preferably gently mixed in order to rehomogenize them (by simply shaking the pot, or optionally with a beater) before being poured into pots sold with the Pacojet® apparatus which is then closed with a cover and frozen for 24 h at −18° C.

### B. Texturing

On the day of tasting, the pots are placed in a standard Pacojet® apparatus (with or without overpressure) in order to texture the frozen mixture in a single run. The grinding time is 3 min 30 s±20 s and the final temperature is −6±1.5° C.

The frozen dessert is tasted immediately. To do this, balls are formed with a standard scoop directly in the pot containing the frozen dessert and the balls are served in a cup, for example at the rate of two different balls per cup. It is thus possible for two people to serve two balls of two different flavors to 70 clients in about 10 minutes.

### Example 2

### Evaluation of the Desserts According to the Invention

Sensory evaluation: The texture of the frozen desserts (desserts 1 to 6 respectively) obtained from the compositions 1 to 6 in Example 1 is very creamy and melting, with practically nonexistent ice crystals and a tasting temperature which is not too cold. The color is rather intense despite the absence of coloring and the taste of the yoghurt is hardly present.

Table 2 groups together more specifically the results obtained with the desserts 1, 3 and 4 obtained according to the process described in Example 1 in which the fruit purees of the compositions 3 and 4 were replaced with raspberry purees, the texturing being carried out under pressure.

TABLE 2
Sensory analysis

| | Dessert 1 | Dessert 3 | Dessert 4 |
|---|---|---|---|
| Spoon | very smooth, | smooth | smooth |
| impression | buttery | | |
| | appearance | | |
| Mouth texture | very creamy, | creamy but quite | very creamy and |
| | melting | firm | very melting |
| Flavor | marked fruity, | very marked | very marked |
| | creamy/milky | fruit | fruit |
| | notes | | |
| Color | fruity | intense fruity | intense fruity |

The desserts 5 and 6 prepared from compositions 5 and 6 are firmer and less sweet than the desserts 1 to 4, but remain very good and creamy, with a buttery texture. The dessert 6 is whiter overall, because it contains more yoghurt, but nevertheless retains a nice raspberry color.

In addition, the dessert 1 prepared without overpressure from the composition 1 in Example 1 is more compact, less aerated, slightly harder than the dessert 1 prepared with overpressure, with a more intense fruity color and taste.

Nutritional values: Table 3 below groups together the nutritional values calculated for the desserts 1 to 6, in which the fruits of the desserts 3 and 4 were replaced by raspberry purees, in comparison with a “fruit yoghurt cream” from DANONE (sold in Europe during the second half of 2005) sold in the fresh food department (best before date 30 days at 4° C.) and with the average for the frozen yoghurts sold in Europe and in the USA (average GNPD 2001-2005).

TABLE 3
Nutritional values

| | | | | | | | Fruit | Frozen | Frozen |
|---|---|---|---|---|---|---|---|---|---|
| | Dessert | Dessert | Dessert | Dessert | Dessert | Dessert | yoghurt | Yoghurt | Yoghurt |
| | 1 | 2 | 3 | 4 | 5 | 6 | cream | Europe | USA |
| kcal/100 g | 134 | 110 | 100 | 135 | 97 | 102 | 130 | 174 | 167 |
| Proteins | 2.1 | 2.4 | 2.4 | 2.3 | 2.2 | 2.5 | 2.4 | 2.6 | 4.1 |
| Carbohydrates | 20.5 | 20.8 | 21.3 | 20.5 | 11.6 | 9.4 | 15.3 | 25.8 | 31.5 |
| Lipids % | 4.9 | 1.9 | 0.6 | 4.7 | 4.64 | 6 | 6.6 | 6.7 | 2.8 |
| Additives | no | no | no | no | no | no | yes | yes | yes |
| Added flavors | no | no | no | no | no | no | yes | yes | yes |
| Yoghurt % | 54.1 | 54.1 | 54.1 | 51 | 51 | 66 | 72 | 31 | ? |
| Fruit % | 31 | 31 | 31.6 | 31 | 44.1 | 30.6 | 18.5 | ? | ? |
| Ferments | >10⁷ | >10⁷ | >10⁷ | >10⁷ | >10⁷ | >10⁷ | >10⁷ | 0 to >10⁷ | 0 to >10⁷ |
| (cfu/g) | | | | | | | | | |

It is evident from this table that the frozen desserts according to the invention have a more balanced composition than that of frozen yoghurts known in the prior art. Indeed, their fat and carbohydrate content is much lower and their calorific value is much lower. In addition, they contain only a small number of constituents, have a texture which is less hard and more creamy than the frozen yoghurts and a more natural and more intense fruity taste despite the absence of added flavor.

Finally, the dessert 4 has a content of fatty acids of the omega-3 type equal to 0.38 g of linolenic acid per 100 g of frozen dessert, a ratio of fatty acids of the omega-6 type to fatty acids of the omega-3 type of less than 5 and only 31.9% of kcal of lipid origin.

Live Ferments Count after Storage:

After freezing for one month at −18° C., the desserts 1 and 2 were textured in the “Pacojet” apparatus, samples were taken, refrozen at −18° C. and sent to an analytical laboratory in order to quantify the viable lactic acid flora. 7×10⁷ CFU/g were counted for the dessert 1 and 8×10⁷ CFU/g for the dessert 2, of which 4×10⁶ CFU/g of B. animalis animalis. These frozen desserts therefore contain live ferments within the meaning of the French regulations.

### Example 3

### Preparation of a Frozen Dessert with Yoghurt and Melon

One prepares the following composition 7:

| | |
|---|---|
| Danone plain set yoghurt | 54% |
| (containing 1% fat) ⁽¹⁾ | |
| Melon puree (fruit equiv.) ⁽²⁾ | 31% |
| Added sugar (including that provided | 15% |
| by the puree) | |

⁽¹⁾ consisting of milk containing 1.05% of fatty substances, concentrated or powdered skimmed milk, lactose, milk proteins, yoghurt lactic ferments, containing 1% of fatty substances, 6.8% of carbohydrates, 3.8% of proteins and 88.4% of water and minerals.
⁽²⁾ freezed, as provided by BOIRON (flash pasteurized with deep-freezing).

The preparation process is the following:

After 24 h thawing at 4° C., the fruit puree is mixed with yoghurt (4° C.) and to icing sugar (20° C.) by means of a dispersing propeller. The mixture is dosed at 700 g in pots for Pacojet™, which are closed by a lid and frozen in an air-pulsing cell at −40° C. until the core temperature becomes less than or equal to −30° C. The pots are then stored at −28° C.

The day of the tasting, these pots at −28° C. are placed in a standard Pacojet™ apparatus which is used without overpressure to texture the frozen mixture in a single run. The grinding time is 3 min 30 sec±20 sec and the final temperature is −6±1.5° C. The pots are then placed closed in a freezer at −9° C. for 7 hours. Then, one forms balls by means of a scoop and the balls are served in cups.

The frozen dessert is then still very creamy and fondant, with almost no ice crystals and a tasting temperature which is not too cold. The colour and taste are typical of fresh fruit, despite the absence of colouring agents and flavours; the taste of yoghurt is not very present.

The nutritional composition is the following

| | Composition M |
|---|---|
| Kcal/100 g | 100 |
| Proteins | 2.4 |
| Glucides | 21.0 |
| Lipids % | 0.7 |
| Additives | No |
| Added flavours | No |
| Yoghurt % | 54 |
| Fruits % | 31 |

Enumeration of the Live Lactic Bacteria after Storage:

After storage for 1, 2, 4 or 6 months at −20° C., the live ferments present in composition 7 has been enumerated according to the following method: the pots containing the desserts have been textured with the Pacojet™ as described above, then the desserts have been sampled and placed at 4° C. for 12 hours, and the viable lactic acid flora has been quantified. Each sample has been textured only once (one has used a separate pot for each storage time). On all of these samples, it has been counted between 2.6×10⁷ and 2.24×10⁸ CFU/g. The frozen dessert therefore contained live ferments within the meaning of the French regulations.

### Example 4

### Frozen Dessert with Yoghurt and Fruits

One prepares the following composition 8:

| | |
|---|---|
| Danone plain set yoghurt | 51% |
| (containing 1% fat) ⁽¹⁾ | |
| Raspberry puree (fruit equiv.) ⁽²⁾ | 31% |
| Added sugar (including that provided | 3.5% |
| by the puree) | |
| Concentrated apple juice (70% dry extract) ⁽³⁾ | 14.5% |

⁽¹⁾ consisting of milk containing 1.05% of fatty substances, concentrated or powdered skimmed milk, lactose, milk proteins, yoghurt lactic ferments, containing 1% of fatty substances, 6.8% of carbohydrates, 3.8% of proteins and 88.4% of water and minerals.
⁽²⁾ freezed, as provided by BOIRON (flash pasteurized with deep-freezing).
⁽³⁾ The dry matter content of fresh apple being 16%, 14.5% of this juice correspond to a fruit equivalent of 63.4%.

The preparation process is the following:

After 24 h thawing at 4° C., the fruit puree is mixed with yoghurt (4° C.) and to icing sugar (20° C.) by means of a dispersing propeller. The mixture is dosed at 700 g in pots for Pacojet™, which are closed by a lid and frozen in an air-pulsing cell at −40° C. until the core temperature becomes less than or equal to −30° C. The pots are then stored at −28° C.

The day of the tasting, these pots at −28° C. are placed in a standard Pacojet™ apparatus which is used without overpressure to texture the frozen mixture in a single run. The grinding time is 3 min 30 sec+20 sec and the final temperature is −6±1.5° C. Then, one forms balls by means of a scoop and the balls are served in cups.

### Tasting:

The frozen dessert is then very creamy and fondant, with almost no ice crystals and a tasting temperature which is not too cold. The colour and taste are typical of fresh fruit, despite the absence of colouring agents and flavours; the taste of yoghurt is not very present.

The nutritional composition is the following

| | Composition 8 |
|---|---|
| Kcal/100 g | 92 |
| Proteins | 2.3 |
| Glucides | 19.4 |
| Lipids % | 0.5 |
| Additives | No |
| Added flavours | No |
| Yoghurt % | 51 |
| Fruit equivalent % | 94.4 |

This composition can slightly vary according to the fruit sources.
   Enumeration of the Live Lactic Bacteria after Storage:

After storage at −20° C. for 6 months, the live ferments present in composition 8 have been enumerated according to the method of Example 4. The result is between 10⁷ and 10⁸ CFU/g: these frozen desserts therefore contain live ferments within the meaning of the French regulations.

1. Process for the manufacture of a frozen dessert, comprising the successive steps consisting in:
(a) freezing a mixture containing a fruit puree and/or juice, yoghurt and optionally added sugars and/or other ingredients, in order to obtain a frozen composition, (b) optionally bringing the said frozen composition to a core temperature ranging from −15 to −25° C. or from −15 to −30° C.,
(c) placing the said frozen composition in a device equipped with grinding means and optionally with aerating means, which device does not comprise extrusion means, and
(d) texturing the said frozen composition with the aid of the said grinding and optionally aerating means.

2. Process according to claim 1, characterized in that the said frozen composition contains from 30 to 49% by weight, preferably from 31 to 40% by weight and more preferably from 31 to 35% by weight of fruit puree and/or juice, as fruit equivalent, relative to the total weight of the composition.

3. Process according to claim 2, characterized in that the frozen composition contains from 49.1 to 220% by weight, preferably from 50 to 150% by weight and more preferably from 50 to 90% by weight of fruit puree and/or juice, as fruit equivalent, relative to the total weight of the composition.

4. Process according to claim 1, characterized in that the fruits are chosen from: apple, banana, strawberry, peach, raspberry, mulberry, mango, kiwi, blueberry, blackcurrant, redcurrant, orange, cherry, fig, pear, apricot, coconut, passion fruit, guava, pawpaw, melon, litchi, pineapple, lemon, mandarin, cherry plum, grapefruit, grape, rhubarb and mixtures thereof.

5. Process according to claim 1, characterized in that the composition is free of fruit containing more than 1.5% t by weight of native starch in the fresh state.

6. Process according to claim 1, characterized in that the frozen composition contains from 51 to 70% by weight of yoghurt, relative to the total weight of the composition.

7. Process according to clam 6, characterized in that the frozen composition contains from 55 to 70%, and preferably 55 to 60% by weight of yoghurt, relative to the total weight of the composition.

8. Process according to claim 1, characterized in that the composition contains at least 10⁵ bacteria per gram.

9. Process according to claim 8, characterized in that the composition contains at least 10⁶ bacteria per gram.

10. Process according to claim 9, characterized in that the composition contains at least 10⁷ bacteria per gram.

11. Process according to claim 8, characterized in that the bacteria contain at least one bacterium chosen from: (a) Streptococcus thermophilics, (b) Lactobacillus delbruekii bulgaricus, (c) Bifidobacterium animalis animalis, (d) Lactobacillus casei, (e) Lactobacillus plantarum, (f) Lactobacillus acidophilus or mixtures thereof.

12. Process according to claim 8, characterized in that the said bacteria contain (a) Streptococcus thermophilus, (b) Lactobacillus delbruekii bulgaricus, and optionally also (c) Bifidobacterium animalis animalis and/or (d) Lactobacillus casei and/or (e) Lactobacillus plantarum and/or (f) Lactobacillus acidophilus.

13. Process according to claim 1, characterized in that the frozen composition contains one or more added sugars in a quantity such that the composition contains less than 25% by weight, preferably less than 23% by weight, more preferably less than 21% by weight of carbohydrates and/or more than 14% by weight of carbohydrates, relative to the total weight of the composition.

14. Process according to claim 1, characterized in that the said sugar is chosen from: sucrose, glucose, fructose, honey, invert sugar, maltose, or mixtures thereof, in particular in a 50:50 ratio.

15. Process according to claim 1, characterized in that the frozen composition contains a nonhydrogenated vegetable oil such as rapeseed oil.

16. Composition according to claim 15, characterized by a content of fatty acids of the omega-3 type (as alpha-linolenic acid equivalent) greater than 0.3 g per 100 g.

17. Process according to claim 16, characterized in that the frozen composition comprises fatty acids of the omega-6 type and of the omega-3 type in a ratio of fatty acids of the omega-6 type to fatty acids of the omega-3 type of less than 5 and in that less than 33% of these calories are of lipid origin.

18. Process according to claim 1, characterized in that the frozen composition is free of lemon juice.

19. Process according to claim 1, characterized in that the frozen composition is free of unfermented cream.

20. Process according to claim 1, characterized in that the frozen composition does not contain any of the following constituents: additives (within the meaning of the Codex alimentarius), in particular texturants, emulsifiers, colorings, preservatives; starch; gelatin; flavors; egg yolk; and mixtures thereof.

21. Process according to claim 1, characterized in that the frozen composition contains a maximum of six ingredients, preferably only three.

22. Process according to claim 1, characterized in chat the frozen composition has an energy value of less than or equal to 155 KCal/100 g, preferably of less than or equal to 140 KCal/100 g, or in an even more desirable manner of less than or equal to 120, or even less than or equal to 100 KCal/100 g.

23. Process according to claim 1, characterized in that the frozen composition contains from 0 to 6% by weight of fatty substances and/or from 1.5 to 3% by weight of proteins.

24. Process according to claim 1, characterized in that it additionally contains, between steps (c) and (d), a step for causing the said frozen composition to cling in the container, by dipping the said frozen composition in an aqueous liquid such as water, or by heating.

25. Process according to claim 1, characterized in that said grinding means comprise a grinding element provided with rotating blades, mounted at the end of a fixed axle, the pot being adapted for moving longitudinally, perpendicularly to the plane of said blades.

26. Process according to claim 1, characterized in that the said grinding means comprise a grinding component provided with rotating blades, mounted at the end of an axle which is suitable for moving longitudinally, perpendicularly to the plane of the said blades.

27. Process according to claim 25, characterized in that the device comprises means for varying the ratio of the speed of rotation of the blades to the speed of longitudinal movement.

28. Process according to claim 1, characterized in that it comprises the additional step of storing the textured composition at a temperature ranging from −6 to −12° C.

29. Frozen dessert, characterized in that it can be obtained according to the process according to claim 1.

30. Frozen dessert according to claim 29, characterized in that it has a content of fatty acids of the omega-S type (as linolenic acid equivalent) of greater than 0.3 g per 100 g of frozen dessert, a ratio of fatty acids of the omega-6 type to the fatty acids of the omega-S type of less than 5 and in that less than 33% of its calories are of lipid origin.

31. Dessert according to claim 29, characterized in that it has an energy value of less than or equal to 155 KCal/100 g, preferably of less than or equal to 140 KCal/100 g, or in an even more desirable manner of less than or equal to 1-20, or even less than or equal to 100 KCal/100 g.

32. Dessert according to claim 29, characterized in that it contains from 0 to 6% by weight of fatty substances and/or from 1.5 to 3% by weight of proteins and/or less than 25% by weight, preferably less than 23% by weight, better still less than 21% by weight of carbohydrates, relative to the total weight of the dessert.
